(19) United States
(12) Patent Application Publication
(10) Pub. No.: US 2022/0380179 A1
(43) Pub. Date: Dec. 1, 2022

(54) ELEVATOR SYSTEM WITH SELF-PROPELLED AUTONOMOUS CAB

(71) Applicant: HYPRLIFT, INC., Wilmington, DE (US)

(72) Inventors: James Hutchinson, Honolulu, HI (US); Robert H. Nakata, Honolulu, HI (US); Daniel D. Johnson, Ann Arbor, MI (US)

(21) Appl. No.: 17/771,006

(22) PCT Filed: Oct. 24, 2020
(86) PCT No.: PCT/US2020/057246

§ 371 Date: Apr. 21, 2022

Related U.S. Application Data
(60) Provisional application No. 62/925,748, filed on Oct. 24, 2019.

(51) Int. Cl. B66B 9/00; B66B 11/00; B66B 9/02; B66B 1/34; B66B 1/06

(52) U.S. Cl. CPC B66B 9/003; B66B 11/0005; B66B 9/02; B66B 1/3461; B66B 1/06; B66B 2201/30

(57) ABSTRACT

An elevator system wherein a cab is moved within a shaft by a tractive drive system that transmits torque frictional force on the interior surface of the shaft, enabling the cab to travel without cables and travel for long distances. The tractive drive system automatically regulates these normal forces. A method of controlling a plurality of these cabs disposed within a plurality of shafts by means of electronic systems.

### CROSS-REFERENCE TO RELATED APPLICATIONS

This application claims the benefit of U.S. Provisional Patent Application Ser. No. 62/925,748, filed on Oct. 24, 2019, incorporated herein in its entirety by reference.

### STATEMENT REGARDING FEDERALLY-SPONSORED RESEARCH OR DEVELOPMENT

Not Applicable.

### FIELD OF THE INVENTION

The present general inventive concept relates to vertical transportation systems (i.e., elevators) which transfer passengers and/or freight within shafts between destinations at differing heights. More particularly the invention relates to elevator systems, in which a plurality of elevator cabs operate in the same shaft without the need for cables to hoist each cab.

### BACKGROUND OF THE INVENTION

Elevators are vertical transportation systems, usually incorporated into buildings, which rely on the use of cabs: mobile compartments that function as vehicles operating along a set track in a vertical shaft (i.e., hoistway). Traditional elevator cabs are externally driven by one or more cables (i.e., ropes) which transfer forces from a stationary drive system affixed to the load-bearing structure of the containing building/structure. In contrast, our invention would revise the design of the traditional cab, where each cab is made to function as an independent vehicle. Rather than the externally-driven, cable-based drive system of traditional elevators, our revised cab design may incorporate a tractive drive system which would adhere to the shaft via friction, as disclosed in European Patent EP 0595122 A1, which is incorporated herein for reference.

A tractive drive system for a vertical transportation system must rely upon frictional forces developed between the moving cab and the stationary shaft in order to regulate the velocity of the cab as desired. Broadly, friction is a resistance to tangential relative motion between two bodies in contact (i.e., sliding against one another) that is produced by the physical interference of microscopic protrusions on the surfaces of both bodies (known as asperities) that deform and/or adhere to one another as the two surfaces are in contact. The exact level of resistance (i.e., force acting in opposition) to the sliding of one body against the other is directly proportional to the normal forces acting to compress the two surfaces together, with the constant of linear proportionality relating the normal and frictional forces to one another known as the coefficient of friction. There are both kinetic and static coefficients of friction, applicable when the two bodies in contact are/are not sliding against one another (respectively). In order to prevent “slipping” of one body's surface against the other, the net force applied to the bodies in a direction tangent to their contacting surfaces must not exceed the maximum static frictional force possible for that unique combination of surface materials, geometries, and normal forces. The static frictional forces needed to support a cab in a shaft may be produced by pressing a plurality of tractive drive units, such as, for example, wheels, tracks, treads, or other similar devices, against the walls of the shaft, creating sufficient normal forces and subsequent static frictional forces of magnitudes large enough to fully cancel out the other forces acting upon the cab, such as, for example, weight of the cab load, acceleration, etc. The static friction effects may be further enhanced with the application of specialized nano-scale texturing of a polymer outer surface (e.g., tire tread) of the tractive drive units, which can produce combined van der Waals force and frictional effects, as described in the inventions disclosed in U.S. Pat. Nos. 7,762,362 B2 and 9,908,266 B2, which are both incorporated herein for reference.

The tractive drive system mentioned above as prior art was never successfully applied due to the impracticality of constructing such a system with the suggested technology and design proposed at the time. This invention uses advances in power density (i.e., the amount of energy stored or delivered per unit mass) of both battery and electric motor technologies that have only previously been applied in other devices. This invention also overcomes another limitation in conventional elevator technology: translation in a single axis of motion that must be controlled by guide rails/tracks along the full length of the shaft. Our invention is also able to meet several objectives that are impossible with prior art. First, cabs may control their angular orientation about an axis of rotation parallel to the axis of translation without the need for guide rails/tracks to be installed within the shaft. Second, cabs may alter their angular orientation about the same vertical axis of rotation during ascent/descent in order to align cab doors with shaft doors, which may now be placed at any angular orientation about a cylindrical shaft. Third, multiple cabs may operate independently within the same shaft, thus increasing the maximal occupancy of each shaft. Finally, fewer shafts would be required for this proposed system, when compared to existing cabled elevator technology, in order to provide the same level of passenger throughput within a comparable building. The present invention can continue operating regardless of its distance from the lowest point of its containing shaft, up to at least 1,600 meters.

There is a need in the marketplace to accommodate more efficient vertical transport, both for residential and commercial buildings. Current commercial embodiments of vertical transport systems are limited by the number of cabs which may operate simultaneously within a single shaft and cannot practically extend beyond the maximal length of the cables used to hoist those cabs. A single shaft cannot practically accommodate many cable-hoisted cabs, therefore the number of cabs per shaft in the current embodiments is limited. Cable length is itself constrained by the tensile strength and mass of the cables. The present invention meets an unmet need in the market by introducing a vertical transport system that accommodates more concurrently-operating multidirectional cabs than the present state of the artin order to optimize transport whilst using a minimal amount of internal volume in the containing building.

### SUMMARY OF THE INVENTION

The present invention resides in one aspect in an elevator system including one or more self-propelled elevator cabs operating in one or more cylindrical vertical shafts. The cylindrical vertical shafts may be networked or otherwise interconnected to permit one or more cabs to transfer from one cylindrical vertical shaft to another. Each cab is propelled by means of one or more tractive drive units, which may be grouped into tractive drive assemblies, that use frictional forces generated by means of controlled compression of the unit(s) into the shaft walls, as well as one or more internal driving actuators and one or more internal energy sources to create vertical motion within the shaft with simultaneous rotation motion about the vertical axis of travel motion and/or hold position. Cab angular orientation about the vertical axis of travel may be controlled by means of steering the tractive drive unit(s) and/or rotation of the passenger compartment. The present invention may comprise one or more mechanisms for generating and controlling rotational motion of the cab about the axis of travel as well as translational motion in any spatial direction within the shaft without the need for guide rails, tracks, or grooves installed within the shaft.

### BRIEF DESCRIPTION OF THE DRAWINGS

FIG. 1 is a sectional view of a portion of a cylindrical vertical shaft and an elevator cab;

FIG. 2 is an orthogonal top view of the cylindrical vertical shaft and the elevator cab showing contact between the tractive drive units within a tractive drive assembly and the interior surface of the containing cylindrical vertical shaft;

FIG. 3 is an orthogonal top view of one embodiment of the cylindrical vertical shaft and the elevator cab showing an array of brake system components;

FIG. 4 is a cross-sectional side view of a plurality of cylindrical vertical shafts, the elevator cab, and a transfer station relocating the cab from one cylindrical vertical shaft to another by means of linear translation of a plurality of cradles;

FIG. 5 is an illustration of an alternative embodiment of a transfer station, wherein the cab is relocated by means of a revolving plurality of cradles rotated about a central axis parallel to the cylindrical vertical shafts;

FIG. 6a. is an isometric view of the tractive drive assembly;

FIG. 6b is an isometric view of the tractive drive assembly showing the tractive drive units rotated about an axis of steering to induce rotation of the cab along with vertical motion;

FIG. 7 is a cross-sectional view of a single tractive drive unit and associated portion of the steering mechanism within the tractive drive assembly, as well as an internal inset view of the tractive drive unit; and

FIG. 8 is a schematic view of a sensor array operating within each cab.

### DETAILED DESCRIPTION

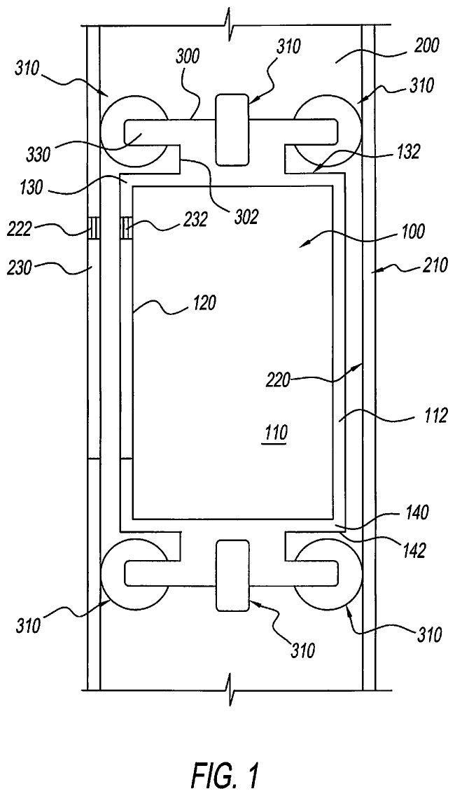

As shown in FIG. 1, an elevator cab 100 is disposed within a cylindrical vertical shaft 200. In one embodiment, the elevator cab 100 has a plurality of tractive drive assemblies 300. The tractive drive assembly 300 comprises one or more drive wheels 310 held within a wheel brace 330. Each wheel 310 is a rotatable member in a torque transmitting relationship with an interior surface 220 of a cylindrical vertical shaft 200.

As shown in FIG. 1., the elevator cab 100 surrounds a passenger or freight compartment 110, as defined by a compartment wall 112. The compartment 110, in one embodiment, further defines a cab door 120. In one embodiment, the cab door 120 may open and close. A shaft door 230 may be disposed in the vertical shaft 200. In one embodiment, the shaft door 230 may open and close. In one embodiment, as shown in FIG. 1, the cab door 120 may be aligned with the shaft door 230 such that when both the cab door 120 and the shaft door 230 are in an open position, a passenger or freight outside the vertical shaft 200 could pass through both the shaft door 230 and the cab door 120 to enter the compartment 110, or a passenger or freight inside the compartment 110 could exit the compartment 110 by passing through both the cab door 120 and the shaft door 230.

In one embodiment, the cab door 120 may align with any one of a plurality of shaft doors 230 disposed at different heights in the vertical shaft 200. In another embodiment, elevator cab 100 may be circumferentially rotated within the vertical shaft 200 such that the cab door 120 may align with any one of a plurality of shaft doors 230 disposed at different points around the vertical shaft 200 circumference.

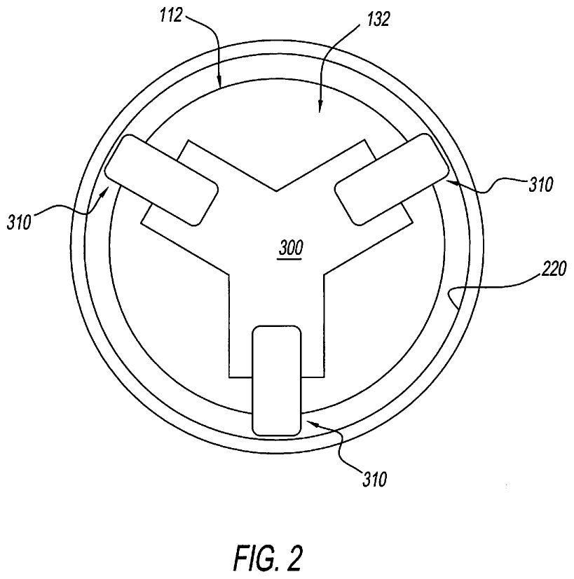

As shown in FIG. 2, in one embodiment, a plurality of drive wheels 310 are arranged in the tractive drive assembly 300 and in a torque transmitting relationship with the interior surface 220. The tractive drive assembly 300, in one embodiment, is fixably attached to an exterior surface 132 of a cab top 130. In another embodiment, a second tractive drive assembly 300 is fixably attached to an exterior surface 142 of a cab bottom 140. In one embodiment, as shown in FIG. 2, there are 3 equally-spaced wheels 310 disposed around the circumference of the elevator cab 100.

In one embodiment, the wheels 310 comprise a set of “drive wheels” that have outer diameters 311 nearly one half that of the internal diameter of the shaft interior surface 220. For example, in a 2 meter (inner diameter) shaft interior surface 220, each drive wheel 310 may have an outer diameter 311 as large as 0.4 meters. As shown in FIG. 1, in one embodiment, the cab 100 is driven by a set of six of these drive wheels 310, divided into two sets of three, mounted at equidistant points around the diameter of the cab in two mirrored tractive drive assemblies 300 fixed to the roof 132 and floor 142 of each cab. In this embodiment, each drive wheel 310 may have an internal gear train 351, that may have a two-stage, static gear ratio.

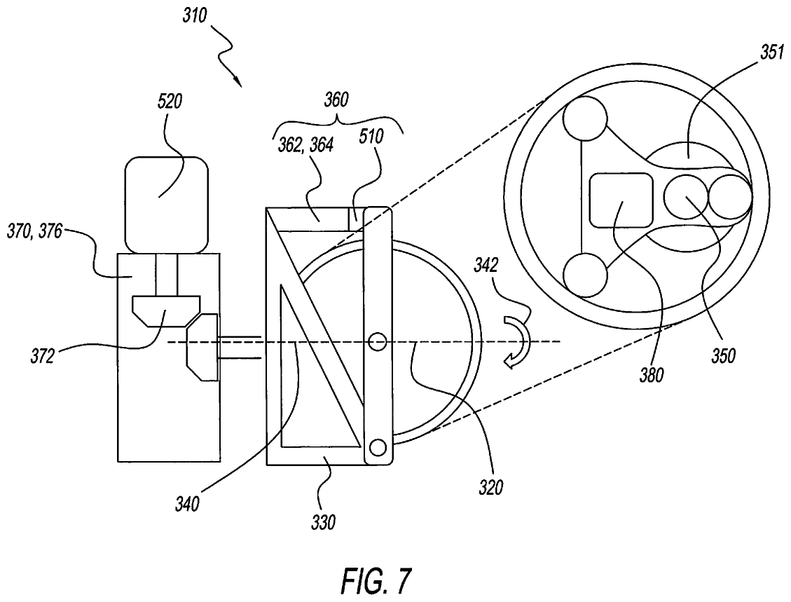

As shown in FIG. 7, in one embodiment, each drive wheel 310 is drivably connected to an internal drivetrain 350 by means of a central hub 320. The drive train 350 is powered by a drive wheel motor 380. In one embodiment, the drive wheel motor 380 is powered by a cabled connection to an electrical circuit. In another embodiment, the drive wheel motor 380 is powered by wireless transmission through the vertical shaft 200. In one embodiment, the drive wheel motor 380 is controlled wirelessly by a receiver 610 connected to a central operating system 600. In one embodiment the drive wheel motor 380 is a lightweight, alternating current electric motor with a high “power density,” here meaning level of sustained mechanical power output per unit mass, on the order of 1,500 W/kg or greater. In one embodiment, the torque transmitted between each drive wheel 310 and the interior surface 220 is at least 1,765 Nm.

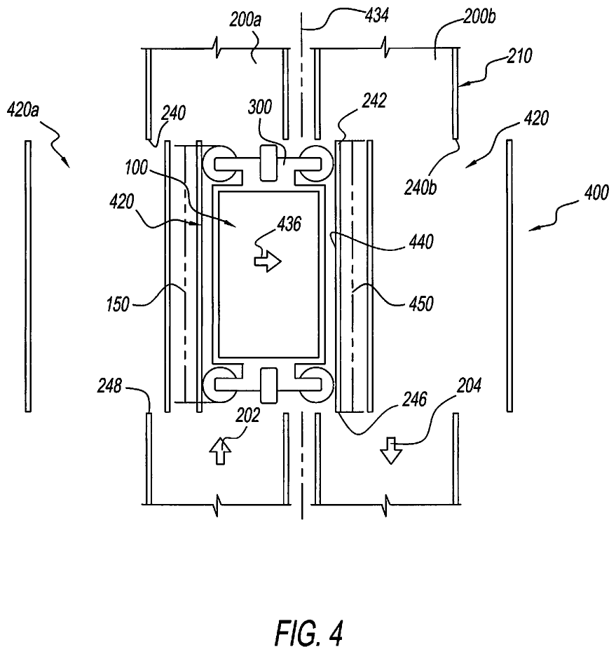

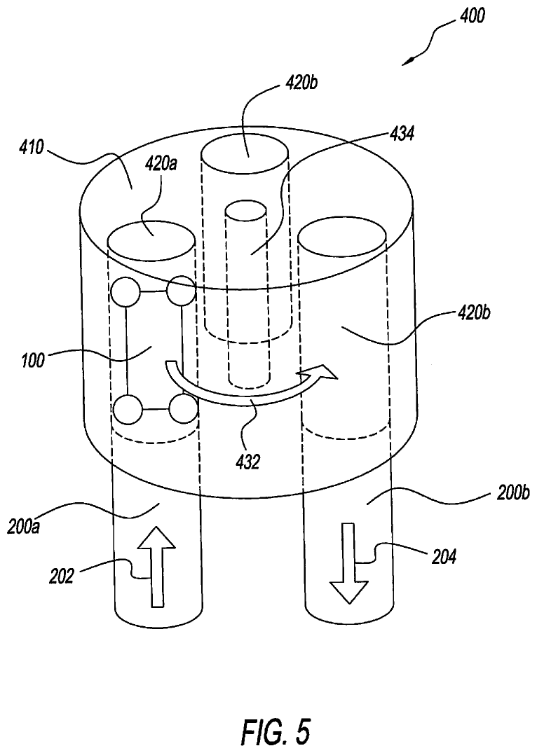

As shown in FIG. 2, each drive wheel 310 will be connected to an independent suspension unit 360 and mounted within a drive wheel brace 330. As shown in FIG. 7, in one embodiment, the drive wheel brace 330 and independent suspension unit 360 compresses the drive wheel 310 into the interior surface 220 in a direction normal to the internal shaft surface and direction of vertical travel by means of a passive single-axis compressive actuator 362 and an active single-axis compressive actuator 364. As shown in FIGS. 4 and 5, in one embodiment, for example, a vertical upward direction 202 can be taken by any cab 100 in a shaft 200a while a vertical downward direction 204 can be taken by any cab 100 in a shaft 200b. In one embodiment, the passive single-axis compressive actuator 362 is a mechanical spring. In another embodiment the passive single-axis compressive actuator 362 is a sealed pneumatic or hydraulic cylinder. The active single-axis compressive actuator 364 dynamically maintains the default position of and compressive force applied to the drive wheel 310. In one embodiment, the active single-axis compressive actuator 364 is a linear actuator.

As further shown in FIG. 7, the active single-axis compressive active actuator 364 will precisely regulate the nominal compressive force applied each drive wheel 310 whilst the passive single-axis compressive actuator 362 will allow some deflection in the event of discontinuities or shocks and smooth the vertical motion, improving ride quality. The exact compressive force applied to each drive wheel 310 will be measured in real time by means of instrumentation such as, in one embodiment, a plurality of load cells 510 mounted along the compressive axis of the independent suspension unit 360, whose data will then be fed to an onboard electronic control system 500 than can adjust the active single axis compressive actuator 364 of each independent suspension unit 360 in order to increase or decrease the nominal compressive load and/or normal force and resulting frictional forces on each drive wheel.

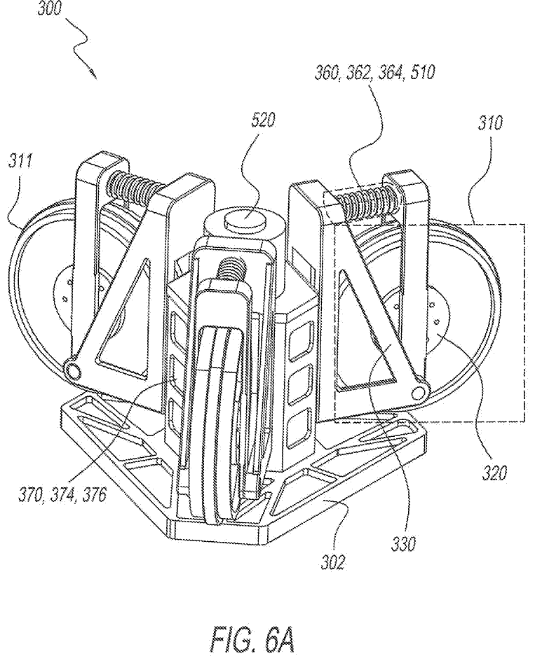

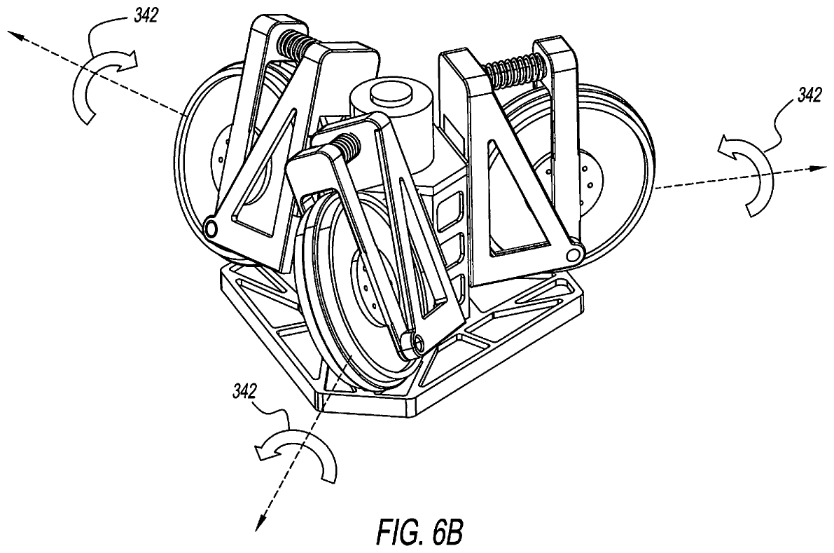

As shown in FIG. 6b, each drive wheel brace 330 may be able to rotate about the axis of applied normal force in order to steer each drive wheel 310, on the order of ±15° from vertical, and produce a net rotation of the cab 100 about the vertical axis of travel within the shaft 200. The steering angle of each drive wheel brace 330 in a tractive drive assembly 300 would be coupled by means of a centralized transmission unit 370.

In one embodiment, the centralized transmission unit 370 incorporates one beveled output gear to each drive wheel brace 330 driven by a central steering pinion 372 rotating about the axis of vertical travel with torque supplied by an electric steering motor 520. In another embodiment, the electric steering motor 520 may be coupled to the central steering pinion 372 by means of a driving worm gear 374. In another embodiment, the centralized transmission unit 370 includes a central steering gear box 376 coupled to the electric steering motor 520 and drive wheel braces 330. The centralized transmission unit 370 may be in communication with the central operating system 600 in order to ensure synchronous steering orientation of all drive wheels 310 as the cab is made to rotate. This steering mechanism allows the cab 100 to align the cab door 120 with passenger access doors 230 positioned at nearly any location around the circumference of the shaft.

Each cab 100 may also use dynamic braking to both control descent and recapture some of the kinetic energy of the cab 100 into potential energy stored within an onboard energy reservoir such as, for example, batteries, ultracapacitors, and/or other similar devices), that would then be used to augment the energy required for the cab's 100 ascent. Due to the rapid delivery/removal of energy required for each cab, in one embodiment of this energy storage/delivery system would consist of ultracapacitors to deliver or absorb short-duration power bursts, paired with lithium polymer batteries for larger energy storage that is slower to charge/discharge.

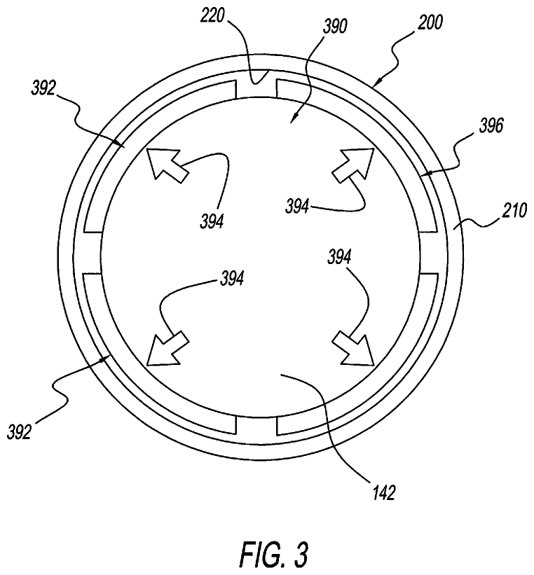

As shown in FIG. 3, an array of emergency brake shoes 392 may be arranged, in one embodiment, in a circumferential array, serving as an emergency braking system 390. Each cab 100 may incorporate the emergency braking system 390 that would activate in the event of a tractive drive system failure (wherein the cab loses partial/full traction with the shaft in a manner unable to be compensated for with independent suspension unit adjustments) or loss of power. When initiated, the emergency braking system 390 would push a plurality of brake shoes 392 from within the cab 100 against the interior surface of the shaft 220 and the ensuing friction would slow, and eventually stop the cab 100 from descending.

As shown in FIG. 4, one or more transfer stations 400 connect a plurality of shafts 200. In one embodiment, the transfer station 400 connects two shafts 200 at an intermediate level. In another embodiment, the transfer station 400 connects two shafts 200 at a terminal end thereof. In one embodiment, the transfer station 400 comprises electromechanical assemblies that contain a transpositioning system 410 capable of translating a cradle 420, comprising a discontinuous segment of the shaft 200 large enough to carry a single cab, at a minimum, between two adjacent shafts 200a and 200b. In one embodiment, the cradle 420 is contiguous with the shaft wall 210. In addition to transferring cabs between adjacent shafts, transfer stations 400 may also add or remove cabs 100 from service for maintenance and/or storage, both of which would likely be located at the base of the shaft network of each elevator system.

In one embodiment, as shown in FIG. 4, the transpositioning system 410 is a rail system. In another embodiment, the transpositioning system 410 is a roller system. In another embodiment, the transpositioning system 410 is a belt-driven system. In another embodiment, the transpositioning system 410 is a chain-driven system. In one embodiment, the transpositioning system 410 executes linear translation, that is, perpendicular to the vertical axis of travel of the cab 100.

As further shown in FIG. 4, in one embodiment, the transpositioning system 410 provides a linear force in a direction 436 on the cradle 420, which has an upper cradle end 242 and a lower cradle end 246. In one embodiment, the cab 100 is aligned with the upper cradle end 242 and lower cradle end 246 such that the entire compartment wall 112 and the tractive drive assembly 300 are contiguous within the cradle 420 and an interior cradle wall surface 440. The cradle 420 is sized so that a cradle height 450 exceeds a total cab height 150 by at least 3 inches, such that the entirety of the cab 100 and each of the tractive drive components 300 are fully enclosed in the cradle 420. Each of the drive wheels 310 exert enough force on the interior cradle wall surface 440 to hold the cab 100 static in position fully enclosed in the cradle 420.

In one embodiment, the static shaft 200 has a static wall lower edge 240. When the cab 100 is in motion within the static shaft 200, the static wall lower end 240 and the upper cradle end 242 are seamlessly tessellated. In this embodiment, the lower cradle end 246 is seamlessly tessellated with a static wall upper end 248, such that the drive wheels 310 may smoothly roll across the interior shaft wall surface 220 and the interior cradle wall surface 440.

As further shown in FIG. 4, the transpositioning system 410 causes the cradle 420a, in which is disposed the cab 100, to laterally move, separating from vertical shaft 200a and becoming aligned with vertical shaft 200b. When the occupied cradle 420a is aligned with a shaft 200b, the cab 100 may smoothly travel by means of its tractive drive 300. In this way, a cab 100 may be removed from the cylindrical vertical shaft 200 to another, or to a holding cradle, without disrupting the path of travel along the interior shaft wall surface 220 of any other cab 100 that may be disposed in the cylindrical vertical shaft 200. As shown in FIG. 4, in one embodiment, an second occupied or empty cradle 420b is also transposed by the transpositioning system 410 to seamlessly tessellate with shaft 200a such that another cab, not shown, may travel through the transfer station 400.

In one embodiment, as shown in FIG. 5, a cradle 420a disengages from a first static shaft 200a and travels revolvably in direction of cradle rotation 432 about the axis of the transpositioning system 434, carrying the cab 100 towards a second static shaft 200b. As shown in FIG. 5, the direction of cradle rotation 432 is counterclockwise. In another embodiment, the direction of cradle rotation 432 is clockwise. In this embodiment, the cab 100 inclusive of any tractive drive assembly 300 is fully disposed within the cradle 420 between the upper cradle end 242 and the lower cradle end 246.

As shown in FIG. 5, in another embodiment, the transpositioning system 410 executes a rotational motion, akin to the rotating chambers in a revolver magazine. The transfer station 400 replaces the removed occupied cradle 420a with another cradle 420b, which may be occupied or empty. Once the translated cradles 420 are aligned with the rest of each shaft 200, any stored cab(s) 100 may exit and continue motion within the adjacent shaft 200.

In one embodiment, the transpositioning system 410 can open such that a cab 100 can be placed at rest outside of alignment of any vertical shaft 200. In one embodiment, the cab 100 may be removed or accessed by a user for maintenance, storage, repair, or replacement.

As shown in FIG. 6a, in one embodiment, the tractive drive assembly 300 has three drive wheels 310 fixed to equidistant triangular points around the tractive drive assembly 300, each secured within a drive wheel brace 330. In one embodiment, a basal platform 302 secures the tractive drive assembly 300 to the cab top 130.

Because a plurality of cabs 100 may travel within the same shaft 200, in one embodiment, one shaft 200a would be allocated to upward-traveling cabs 100 and another shaft 200b downward-traveling cabs 100. The operating system 600 processes a plurality of inputs to determine optimal allocation of cabs 100 to each directional shaft 200, such as, for example, upward-traveling or downward-traveling. In one embodiment, anticipated user activity at a given time of day will inform that more shafts would be allocated to upward traveling cabs during peak up-demand periods (e.g., beginning of the workday) and more shafts to cabs traveling downward during peak down-demand periods (e.g., end of the work day), thereby optimizing the overall system's vertical transport efficiency of the elevator system.

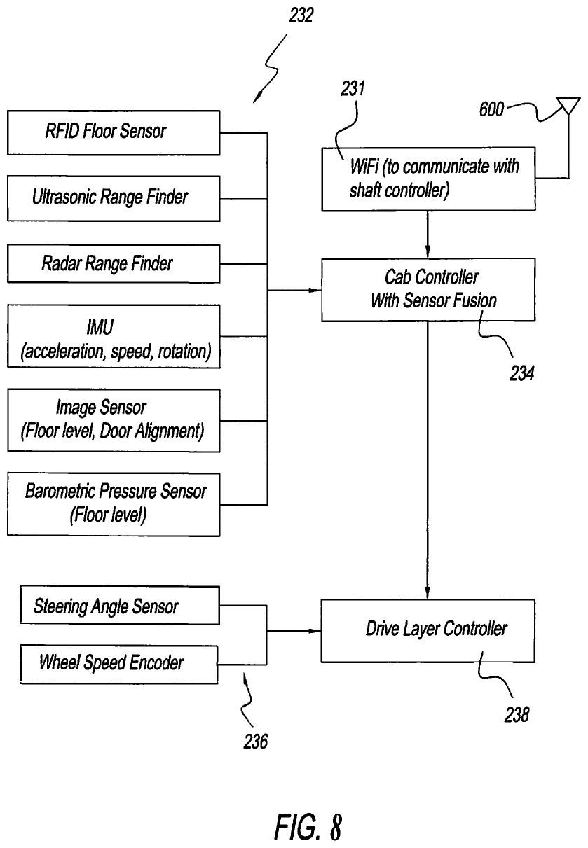

Optimized cab traffic scheduling and/or destination dispatch may be accomplished with the operating system 600 that, in one embodiment, includes an artificially intelligent operating system in dynamic communication with a plurality of cabs 100 via a private secured wireless network 630. In another embodiment, the operating system 600 is controlled by a central processing unit. As shown in FIG. 1, one or more shaft sensors 222 are disposed proximate to any shaft door 230 and are in communication with the operating system 600. Each cab 100 further has one or more sensors 232 in communication with the operating system 600 via a cab controller module 234. As shown in FIG. 8, in one embodiment, the shaft sensors 222 are in communication with a shaft controller 231.

As shown in FIG. 8, in one embodiment, the sensors 232 comprise RFID sensors that determine where the cab 100 is along the shaft 200, inertial measurement units that measure speed, rotation, and acceleration of the cab 100, and imaging sensors that measure alignment with the doors 230. The cab sensors 232 are in communication with a cab controller 234. As further shown in FIG. 8, in one embodiment, there is a tractive drive controller 238 in communication with the cab controller 234. The tractive drive controller 238 is in communication with a plurality of drive sensors 236. In one embodiment, as shown in FIG. 8, the drive sensors 236 comprise steering angle sensors that detect the degree to which the wheels 310 may be rotated, speed encoders that detect motion of the wheels 310, one or more load cells 510 that detect the load borne by the independent suspension units 360, temperature sensors, voltage sensors, and current sensors.

The operating system is in communication with this plurality of sensors and control algorithms that use the sensor inputs to measure and control the speed, position, and rotation of the cab to facilitate alignment with floor level door openings that vary from floor to floor. Rotational sensors may include accelerometers, gyroscopes and magnetometers, combined within an inertial measurement unit, and provide the precise rotational position of the cab. A steering angle sensor and a wheel speed encoder for each drive wheel 310 may be used in a closed loop control algorithm to position the cab in the correct rotational position. Image sensors can provide further alignment accuracy. The sensors may include radar and ultrasonic ranging sensors that measure the distance to another cab that is above or below the cab. In one embodiment, a barometric sensor measures the absolute altitude to determine the height above ground level to determine the corresponding building floor level. Additionally, optical sensors detect the floor level by reading QR codes applied to the shaft wall, where each QR code is associated with a specific floor level. In another embodiment, Radio Frequency Identification sensors are used to further determine the cab's present floor location. In another embodiment, each of these sensors are combined using sensor fusion to increase the position accuracy of the cab.

In another embodiment, the operating system 600 is decentralized, with software and processing distributed amongst multiple cabs 100 within the network, all connected by means of a secure wireless cab-to-cab mesh network or similar local private wireless communication network topology.

In another embodiment, the operating system 600 is also in communication with passengers via their mobile devices. In one embodiment, passengers may communicate with the elevator system, such as for example to hail an elevator cab 100, using installed consoles at each door 230. In another embodiment, passengers may communicate with the elevator system via a mobile device 650. In another embodiment, the mobile device 650 device may join a wireless communications network 630 by communicating with a receiver 610. In another embodiment, the mobile device 650 is in communication with the operating system 600 by means of encrypted communications through the public internet.

It is understood that in other embodiments of the present invention the arrangement of drive wheels 310 may be any combination of the types described above. It is understood that in other embodiments of the present invention, the cab 100 may be composed of any combination of materials. It is understood that in other embodiments of the present invention any number or type of cab sensors 232 and/or drive sensors 236 may be used. It is understood that in other embodiments of the present invention, the power sources for any of the tractive drive system 300, the transpositioning system 410, and/or the shaft doors 230 and cab doors 120 may be wired, wireless, battery powered, or otherwise powered by any reasonable means. It is understood that in other embodiments of the present invention shafts may run in directions other than vertical. It is understood that in other embodiments of the present invention shafts may be of shapes other than cylindrical.

A number of embodiments of the invention have been described. Nevertheless, it will be understood that various modifications may be made without departing from the spirit and scope of the invention. Accordingly, other embodiments are within the scope of the following claims.

1. An elevator system comprising:
at least one vertical shaft,
at least one cab, wherein
at least one tractive drive system attached to the cab is transmitting frictional forces to a surface within the vertical shaft;
the tractive drive system automatically regulates normal forces applied to a surface within the vertical shaft; and
said tractive drive system is controlled by one or more electronic systems
wherein there are two or more vertical shafts; and
wherein the cab translocates from one vertical shaft to another vertical shaft, by means of a transpositioning system.

2. (canceled)

3. (canceled)

4. An elevator system of claim 1 wherein the tractive drive system permits the cab to rotate 360 degrees within the vertical shaft, the vertical shaft being cylindrical in shape.

5. An elevator system of claim 1 wherein the electronic control system detects and controls the cab's location vertically and circumferentially within the vertical shaft.

6. The elevator system of claim 1 that includes a WiFi wireless communications system to communicate with the shaft controller and adjacent cabs.

7. A method for controlling an elevator system including at least one autonomous self-propelled cab and at least one vertical shaft, comprising:
an operating system;
at least one cab sensor in communication with a cab controller;
at least one drive sensor in communication with a drive controller;
at least one shaft sensor in communication with a shaft controller, wherein
the operating system receives and processes sensor information from the cab controller, the drive controller, and the shaft controller to dispatch a cab to a pre-determined point within the vertical shaft
translocating the cab from one vertical shaft to another vertical shaft, by means of a transpositioning system.

8. The method of claim 8 wherein there are a plurality of cabs in the shaft.

9. The method of claim 8 wherein there are a plurality of shafts connected by a transfer station.

10. The method of claim 9 wherein the operating system dispatch the movement of each of the plurality of cabs to optimize passenger travel between floors of a building.

11. The method of claim 9 wherein each of the plurality of cabs is in communication via a wireless mesh network.
